(19) United States
(12) Patent Application Publication
(10) Pub. No.: US 2017/0202735 A1
(43) Pub. Date: Jul. 20, 2017

(54) SPA CONTROL WITH NOVEL HEATER MANAGEMENT SYSTEM

(71) Applicant: JERRELL HOLLAWAY, MELBOURNE, FL (US)

(72) Inventor: JERRELL PENN HOLLAWAY, MELBOURNE, FL (US)

(73) Assignee: JERRELL HOLLAWAY

(21) Appl. No.: 14/995,331

(22) Filed: Jan. 14, 2016

(51) Int. Cl. A61H 33/00

(52) U.S. Cl. CPC A61H 33/0095; A61H 33/005; A61H 2201/501; A61H 2201/5082; A61H 2201/0207; A61H 2201/0228

(57) ABSTRACT

A spa control system where the spa's heater is disconnected from the power source anytime the water in the heater is at a higher temperature than that set by the user by a prescribed amount. Since the control system has a regular temperature management'system this will only occur because of a problem in the spa or the control system itself. Independent paths between a pair of temperature sensors in the heater and the relays that connect line voltage to the heater are provided to meet the safety requirements of UL. Two sensors in the heater are co-located in a metal tube, placed near the heater.

### BACKGROUND OF THE INVENTION

One of the biggest safety concerns with a spa, or hot tub, is the management of the heater. For several years all spa controls used a pressure switch to determine that the spa's pump was running circulating the water in the spa through the heater. If a spa was turned on without sufficient water, for example, the electric heating element could quickly overheat, causing damage to the spa and nearby structures. A pressure switch could prevent this from happening. The only problem was the unreliably of the switch itself.

Underwriters Laboratories insists that a heat sensing device of some kind he placed on or within the heater to recognize an overheating problem and then to quickly disengage the heater. This device was to be in addition to the primary heater control. Because of this requirement, most spa controllers have been built with a temperature sensor in the spa water and another sensor on the heater. The sensor on the heater would declare a problem whenever the temperature reached a predetermined level, usually 116 to 118 degrees F. An approach was taught by Cline et, al in U.S. Pat. No. 6,282,370 wherein a pair of sensors are placed on opposite ends of the heater and the heater is turned off whenever there is a prescribed difference between the values of the sensors, meaning that insufficient water is flowing through the heater.

A better approach was taught by Hollaway in U.S. Pat. No. 8,392,027. This approach was to use a single sensor inside the heater, near the heating element, and to monitor the temperature for a rapid rate of change. If the rate of change is greater than a normal rate it is because the flow of water through the heater is missing or too low. The present invention teaches yet another approach that is simpler than anything else done to date.

### SUMMARY OF THE INVENTION

The heater management system of the present invention solves the safety requirement of UL in an entirely new way. The overheat protection is provided by having, two independent temperature sensors coupled to a microprocessor that controls two relay drivers which, in turn, controls two independent relays connected between the electrical service lines and the heater element itself.

The novel part of this invention is the way that the heater programming detects overheating and shuts down electrical power to the heater. Unlike some of the systems previously described which rely on temperature differentials between two sensors, or a high rate of change observation that indicates a runaway electrical heater, the present invention just compares the water temperature in the heater to the temperature setting provided by the user. If the heater temperature is a prescribed amount higher than the set temperature there has to be a mechanical failure of some sort in the spa or the controller itself. In any event, the heater is turned off and the spa is allowed to cool down.

### BRIEF DESCRIPTION OF THE DRAWINGS

FIG. 1 is a block diagram of the heater management system within the controller.

### DETAILED DESCRIPTION OF A FAVORITE EMBODIMENT

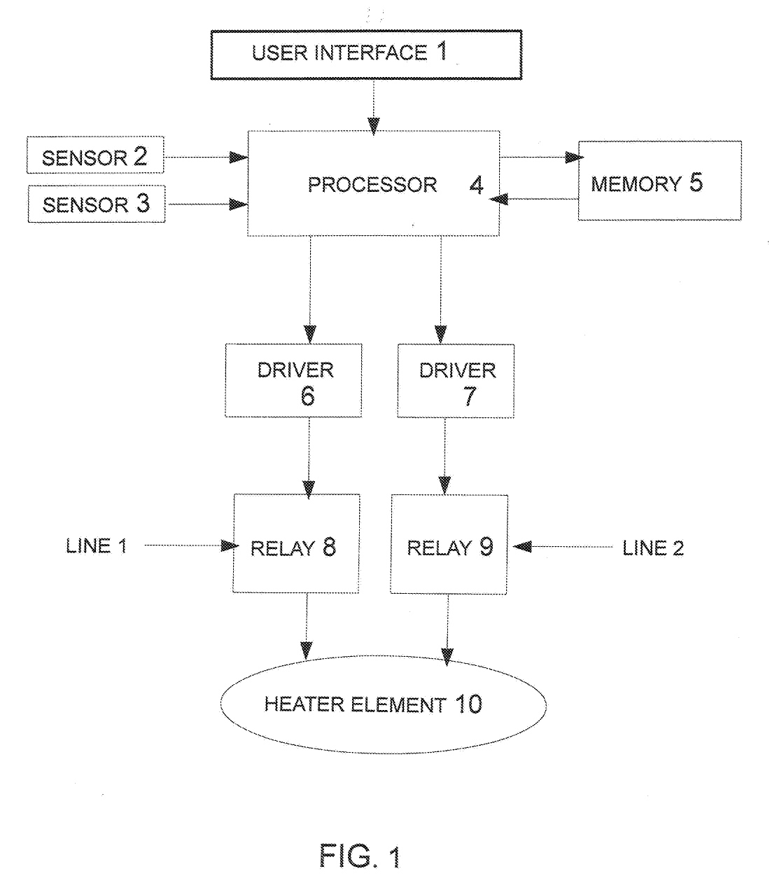

Referring now to FIG. 1, an input panel is provided for the user to set a desired temperature for the water in the spa. This setting is stored in, memory for later comparison with the actual water temperature.

Sensor 1 and Sensor 2 are mounted within the heater, as close as practical to the heating element. It is desirable that 1 and 2 share a common housing, such as a metal tube. Both 1 and 2 are able to see the water temperature near the element and be compared to each other for accuracy. If the difference in readings between the sensors is too great, the heater cannot be turned on, since one or both of the sensors is defective.

Processor 4 receives the values from 1 and 2 and determines if the water is cool enough to allow the heating element 10 to be energized. This is accomplished with signals from the processor activating relay drivers 6 and 7 and the drivers closing relays 8 and 9, which couples lines 1 and 2 to the heater element. In some cases relay drivers may not be necessary. If now the water needs to be heated, a separate heat control relay is activated, as is well known. After electrical power is applied to the heater, sensors 1 and 2 continually monitor the water temperature inside the heater. When the water has heated to the desired temperature, power to the heater element is removed by opening the heat control relay. If the temperature inside the heater is later found to be higher than the user setting by, say 4 degrees, it is only because of a failure of some sort in the rest of the controller, such as a stuck relay. To meet the safety requirements of UL, the processor must remove signals to 6 and 7 and the heater must be turned off until the problem is identified and fixed.

It should be noted that relays 8 and 9 may be replaced with other types of power switches, such as TRIALS. Likewise, the functions of memory 5 may be performed with many devices. In fact, the present embodiment may be replaced with other embodiments without departing from the teaching of the present invention.

I claim:

1. A spa heater management system that prevents overheating of the spa heater by comparing the heater temperature with the user set temperature, comprising:
(a) an interface that allows a user to select a set temperature for the spa water,
(b) memory for storing said setting,
(c) one or more temperature sensors mounted within the heater housing,
(d) a processor coupled to said sensors for receiving values from said temperature sensors and comparing said values with said temperature setting in memory,
(e) relays, or other power switching means, coupled between said processor, a heater element, and electrical service lines for the purpose disconnecting said electrical lines from said heater element whenever said sensors detect a temperature that is a prescribed amount higher than said temperature setting.

2. The system in claim 1, wherein said temperature sensors are located in a common housing.

3. The system in claim 1, wherein said user interface is an input panel.

4. The system in claim 1, wherein said memory is combined with said processor in a common package.

5. A method for meeting safety requirements for an electrical heater in a spa Including the following steps:
(a) receiving user input for the desired water temperature
(b) storing said input in memory,
(c) measuring the water temperature inside the heater,
(d) comparing said input in memory with said measurement,
(e) turning off said heater when the user's selected temperature is met,
(f) disconnecting electrical power from said heater with different electrical switches whenever said measurement is higher than said input by a prescribed amount.
